(19) United States
(12) Patent Application Publication
(10) Pub. No.: US 2026/0060466 A1
(43) Pub. Date: Mar. 5, 2026

(54) SHAFT CONNECTING STRUCTURE AND JUICER

(71) Applicant: Zhongshan Anmir Electrical Appliance Industrial Co., Ltd, Zhongshan (CN)

(72) Inventors: Chuanbao ZOU, Zhongshan (CN); Tianhu TANG, Zhongshan (CN); Li ZHOU, Zhongshan (CN); Huiming ZHANG, Zhongshan (CN)

(21) Appl. No.: 19/090,753

(22) Filed: Mar. 26, 2025

(30) Foreign Application Priority Data
Aug. 28, 2024 (CN) 2024111869211

(51) Int. Cl. A47J 19/02; F16D 1/10

(52) U.S. Cl. CPC A47J 19/025; F16D 1/101; F16D 2001/102

(57) ABSTRACT

A shaft connecting structure and a juicer with the shaft connecting structure are disclosed. The shaft connecting structure includes a first connecting shaft and a second connecting shaft, the first connecting shaft is provided with a receptacle and first correcting grooves, the receptacle is provided with inner angles, each of the first correcting grooves extends to an adjacent side wall of the receptacle, a distance between each of the first correcting grooves and an axis of the first connecting shaft gradually decreases in a concave direction of the receptacle, a width of each of the first correcting grooves gradually decreases in a direction from the receptacle to the respective first correcting groove, the second connecting shaft is provided with a protrusion, and a plurality of second correcting grooves, and a sharp part is formed between adjacent second correcting grooves.

### CROSS-REFERENCE TO RELATED APPLICATION

This application is based on and claims the benefit of priority from Chinese Patent Application No. 2024111869211, filed on Aug. 28, 2024, the entirety of which is incorporated by reference herein.

### TECHNICAL FIELD

The present disclosure relates to the technical field of juicers, and more particularly, to a shaft connecting structure and a juicer.

### BACKGROUND

As is well known, existing juicers typically include a base, a motor, a juicing cup and a screw body. The motor is arranged on the base, the juicing cup is detachably installed on the base. One end of an output shaft of the motor penetrates through the juicing cup and is connected with a transmission shaft of the screw body. In order to facilitate disassembly of the screw body, the transmission shaft of the screw body is typically connected with the output shaft of the motor through a plug-in structure, which includes a receptacle arranged on the transmission shaft and a protrusion arranged on the output shaft. A cross section of the receptacle and a cross section of the protrusion are both non-circular structures, and one end of the output shaft of the motor is inserted into the receptacle and can abut against a side wall of the receptacle, so that the output shaft of the motor can drive the transmission shaft to rotate and the screw body can rotate in the juicing cup.

In order to facilitate installation of the screw body by a user, a fit clearance between the protrusion and the receptacle is typically increased to reduce installation difficulty of the screw body. However, the increased fit clearance between the protrusion and the receptacle allows the transmission shaft to move radially relative to the output shaft of the motor, leading to potential collisions between the transmission shaft and the output shaft of the motor. This results in excessive operational noise during juicer operation.

### SUMMARY

The present disclosure aims at solving at least one of the technical problems in the existing technology. To this end, the present disclosure provides a shaft connecting structure which facilitates installation of a screw body while reducing a fit clearance between a protrusion and a receptacle.

The present disclosure further provides a juicer provided with the shaft connecting structure above.

A shaft connecting structure according to an embodiment in a first aspect of the present disclosure includes:
a first connecting shaft provided with a receptacle and a plurality of first correcting grooves, wherein a cross section of the receptacle is a regular polygon structure in a direction perpendicular to an axial direction of the first connecting shaft, the receptacle is provided with inner angles, the plurality of first correcting grooves are arranged at intervals in a circumferential direction of the first connecting shaft, each of the first correcting grooves extends to an adjacent side wall of the receptacle, a distance between each of the first correcting grooves and an axis of the first connecting shaft gradually decreases in a concave direction of the receptacle, and a width of each of the first correcting grooves gradually decreases in a direction from the receptacle to the respective first correcting groove; and
a second connecting shaft provided with a protrusion, wherein a cross section of the protrusion is matched with the cross section of the receptacle in a direction perpendicular to an axial direction of the second connecting shaft, the second connecting shaft is provided with a plurality of second correcting grooves, the plurality of second correcting grooves are arranged at intervals in a circumferential direction of the second connecting shaft, each of the second correcting grooves extends to a respective side surface of the second connecting shaft, a sharp part is formed between the adjacent second correcting grooves, and one end of the second connecting shaft is accommodated in the receptacle and is capable of moving in the circumferential direction of the first connecting shaft;
wherein, when each of the inner angles is misaligned with the respective sharp part, the sharp part slides into the receptacle from the respective first correcting groove, and the sharp part is in sliding contact with a side wall of the respective first correcting groove, so that the protrusion is inserted into the receptacle.

The shaft connecting structure according to the embodiment in the first aspect of the present disclosure at least has the following beneficial effects.

The first connecting shaft is a shaft body of the screw body, and the second connecting shaft is an output shaft of a motor. When a user installs the screw body, the first connecting shaft is connected with the second connecting shaft, and the user cannot accurately determine relative positions of the inner angles and the respective sharp parts. In most cases, the inner angles are misaligned with the respective sharp parts both in the circumferential direction and the radial direction of the first connecting shaft. By providing the first correcting grooves and the second correcting grooves, when the inner angles are misaligned with the respective sharp parts in the circumferential direction of the first connecting shaft, the sharp parts are abutted with the side walls of the first correcting grooves. As the first correcting grooves each extend to the adjacent side wall of the receptacle, the side walls of the first correcting grooves can guide the respective sharp parts to rotate in a direction towards the inner angles, so as to correct the positions of the inner angles and the sharp parts in the circumferential direction of the first connecting shaft. When the inner angles are misaligned with the sharp parts in the radial direction of the first connecting shaft, the distance between each of the first correcting grooves and the axis of the first connecting shaft gradually decreases in the concave direction of the first connecting shaft, so that the side walls of the first correcting grooves can guide the respective sharp parts to move in the radial direction of the first connecting shaft to correct the positions of the inner angles and the respective sharp parts in the radial direction of the first connecting shaft. This facilitates the installation of the screw body, and reduces the operational noise during juicer operation while reducing the fit clearance between the protrusion and the receptacle.

According to some embodiments of the present disclosure, each of a plurality of connecting edges is defined between two adjacent first correcting grooves respectively, and a length of one of the connecting edges is not equal to a length of other connecting edges.

According to some embodiments of the present disclosure, a distance between a wall surface of each of the second correcting grooves and the respective side surface of the second connecting shaft gradually decreases in a concave direction of the respective second correcting groove.

According to some embodiments of the present disclosure, a width of each of the second correcting grooves gradually decreases in a direction from the respective side surface of the second connecting shaft to an axis of the second connecting shaft.

According to some embodiments of the present disclosure, the cross section of the receptacle is a regular hexagon structure in the direction perpendicular to the axial direction of the first connecting shaft.

According to some embodiments of the present disclosure, a side wall of each of the first correcting grooves is connected with a respective side wall of an adjacent first correcting groove.

According to some embodiments of the present disclosure, the sharp part is provided with a side edge, the side edge is located on one side of the sharp part adjacent to an outer side of the second connecting shaft, one end of the side edge is connected with a center of the protrusion to form a first edge, another end of the side edge is connected with the center of the protrusion to form a second edge, and an included angle between the first edge and the second edge is α, which satisfies: 0<α≤3°.

According to some embodiments of the present disclosure, a projection of each of the inner angles is located in a middle of a projection of the respective first correcting groove in the axial direction of the first connecting shaft.

According to some embodiments of the present disclosure, a bottom wall of each of the first correcting grooves is a curved surface structure.

A juicer according to an embodiment in a second aspect of the present disclosure includes a motor, a screw body and the shaft connecting structure according to the above embodiments, wherein the first connecting shaft is a shaft body of the screw body, and the second connecting shaft is an output shaft of the motor.

The juicer connecting structure according to the embodiment in the second aspect of the present disclosure at least has the following beneficial effects.

When a user installs the screw body, the first connecting shaft is connected with the second connecting shaft, and the user cannot accurately determine relative positions of the inner angles and the respective sharp parts. In most cases, the inner angles are misaligned with the respective sharp parts both in the circumferential direction and the radial direction of the first connecting shaft. By providing the first correcting grooves and the second correcting grooves, when the inner angles are misaligned with the respective sharp parts in the circumferential direction of the first connecting shaft, the sharp parts are abutted with the side walls of the first correcting grooves. As the first correcting grooves each extend to the adjacent side wall of the receptacle, the side walls of the first correcting grooves can guide the respective sharp parts to rotate in a direction towards the inner angles, so as to correct the positions of the inner angles and the sharp parts in the circumferential direction of the first connecting shaft. When the inner angles are misaligned with the sharp parts in the radial direction of the first connecting shaft, the distance between each of the first correcting grooves and the axis of the first connecting shaft gradually decreases in the concave direction of the first connecting shaft, so that the side walls of the first correcting grooves can guide the respective sharp parts to move in the radial direction of the first connecting shaft to correct the positions of the inner angles and the respective sharp parts in the radial direction of the first connecting shaft. This facilitates the installation of the screw body, and reduces the operational noise during juicer operation while reducing the fit clearance between the protrusion and the receptacle.

Additional aspects and advantages of the present disclosure will be given in part in the following description, which will become apparent from the following description or be understood through practice of the present disclosure.

### BRIEF DESCRIPTION OF THE DRAWINGS

The above and/or additional aspects and advantages of the present disclosure will be apparent and easily understood from the description of the embodiments taken in conjunction with the following drawings, wherein:

FIG. 1 is a schematic structure diagram of a screw body according to an embodiment of the present disclosure;

FIG. 2 is a top view of the screw body according to an embodiment of the present disclosure;

FIG. 3 is a partial enlarged view of a portion A in FIG. 2;

FIG. 4 is a schematic structure diagram of a motor according to an embodiment of the present disclosure;

FIG. 5 is a front view of the motor according to an embodiment of the present disclosure;

FIG. 6 is a top view of the motor according to an embodiment of the present disclosure;

FIG. 7 is a partial enlarged drawing of a portion B in FIG. 6;

FIG. 8 is a schematic structure diagram of a sharp part according to an embodiment of the present disclosure;

FIG. 9 is a schematic structure diagram of a juicer according to an embodiment of the present disclosure; and

FIG. 10 is a schematic diagram of an internal structure of the juicer according to an embodiment of the present disclosure.

### REFERENCE NUMERALS

100—first connecting shaft, 110—receptacle, 111—inner angle, 120—first correcting groove, and 130—connecting edge;
200—second connecting shaft, 210—protrusion, 220—second correcting groove, 230—sharp part, 231—side edge, 232—first edge, and 233—second edge; and
300—screw body, 400—motor, 500—base, and 600—juicing cup.

### DETAILED DESCRIPTION

Embodiments of the present disclosure will be described in detail below. Examples of the embodiments are illustrated in the accompanying drawings, where the same or like reference numerals throughout the figures indicate the same or like elements having the same or like functions. The embodiments described below with reference to the accompanying drawings are exemplary and are intended only to explain the present disclosure instead of being construed as limiting the present disclosure.

In the description of the present disclosure, it should be understood that, descriptions relating to orientation, for example, orientation or positional relationships indicated by “up”, “down”, “front”, “back”, “left”, “right”, etc. are based on the orientation or positional relationships shown in the accompanying drawings, and are to facilitate the description of the present disclosure and simplify the description only, rather than indicating or implying that the device or element referred to must have a specific orientation or be constructed and operated in a specific orientation, and therefore cannot be construed as limiting the present disclosure.

In the description of the present disclosure, the meaning of “several” is one or more, the meaning of “a plurality of” is two or more, “greater than”, “less than”, “more than”, etc. are to be understood to exclude the given figure, and “above”, “below”, “within”, etc. are understood to include the given figure. If “first” and “second”, etc. are referred to, it is only for the purpose of distinguishing technical features, and shall not be understood as indicating or implying relative importance or implying the number of the indicated technical features or implying the sequence of the indicated technical features.

In the description of the present disclosure, unless otherwise explicitly defined, the words such as “set”, “install”, and “connect” should be understood in a broad sense, and those skilled in the art can determine the specific meanings of the above words in the present disclosure in a rational way in combination with the specific contents of the technical solutions.

In the related technology, existing juicers typically include a base, a motor, a juicing cup and a screw body. The motor is arranged on the base, the juicing cup is detachably installed on the base. One end of an output shaft of the motor penetrates through the juicing cup and is connected with a transmission shaft of the screw body. In order to facilitate disassembly of the screw body, the transmission shaft of the screw body is typically connected with the output shaft of the motor through a plug-in structure, which includes a receptacle arranged on the transmission shaft and a protrusion arranged on the output shaft. A cross section of the receptacle and a cross section of the protrusion are both non-circular structures, and one end of the output shaft of the motor is inserted into the receptacle and can abut against a side wall of the receptacle, so that the output shaft of the motor can drive the transmission shaft to rotate and the screw body can rotate in the juicing cup. In order to facilitate installation of the screw body by a user, a fit clearance between the protrusion and the receptacle is typically increased to reduce installation difficulty of the screw body. However, the increased fit clearance between the protrusion and the receptacle allows the transmission shaft to move radially relative to the output shaft of the motor, leading to potential collisions between the transmission shaft and the output shaft of the motor. This results in excessive operational noise during juicer operation.

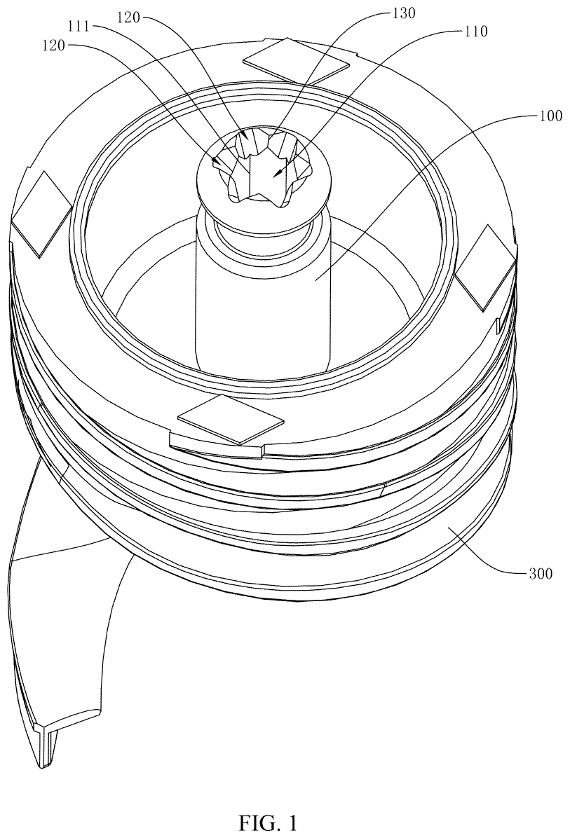

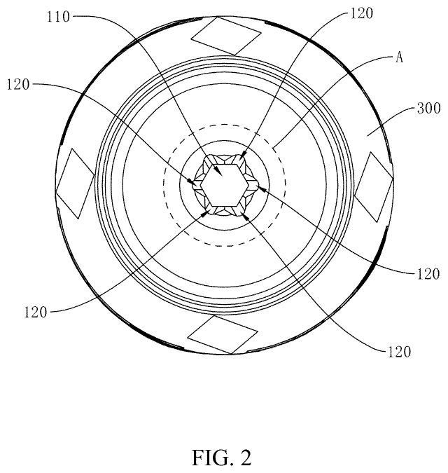

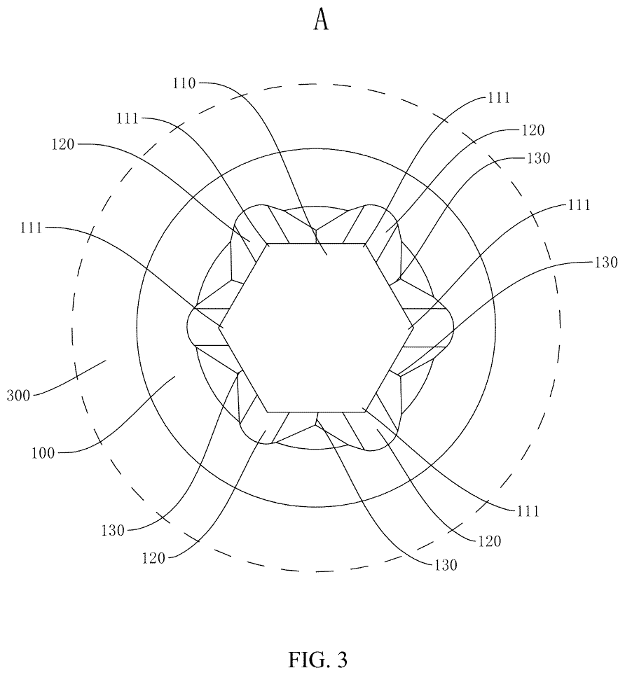

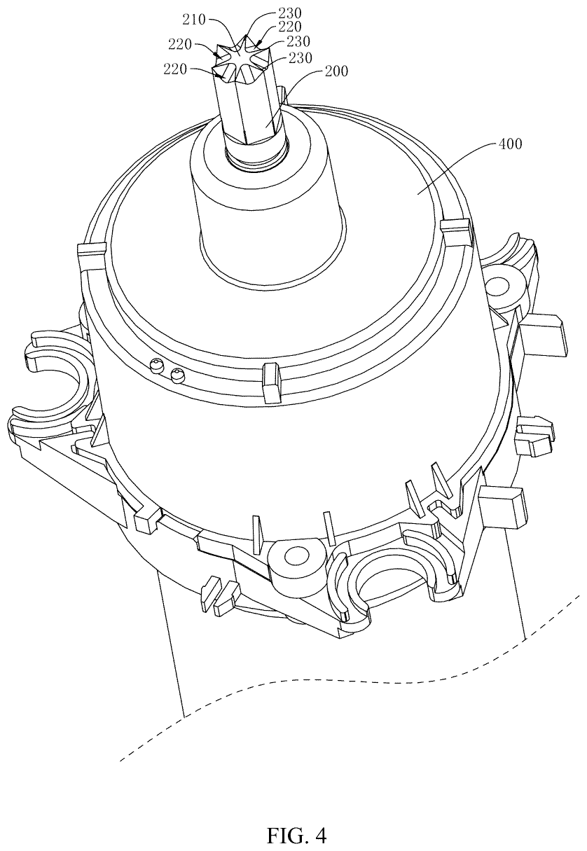

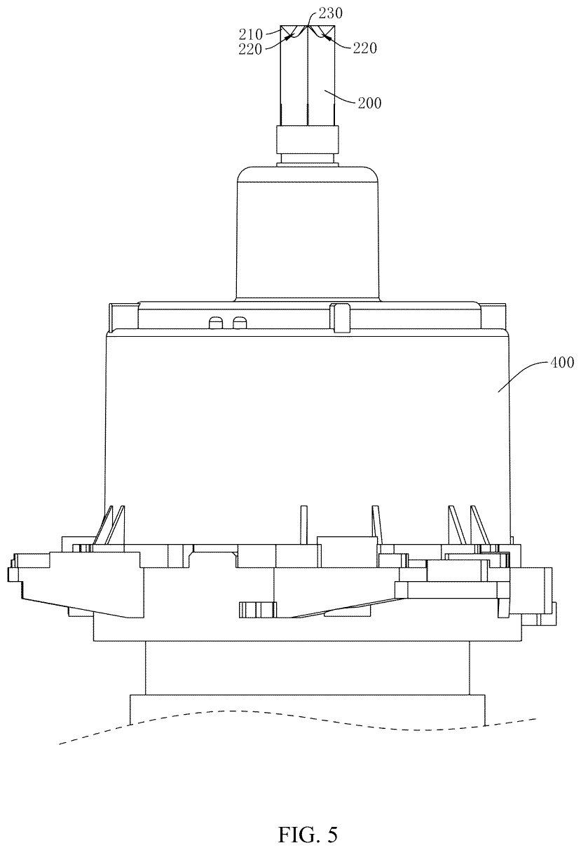

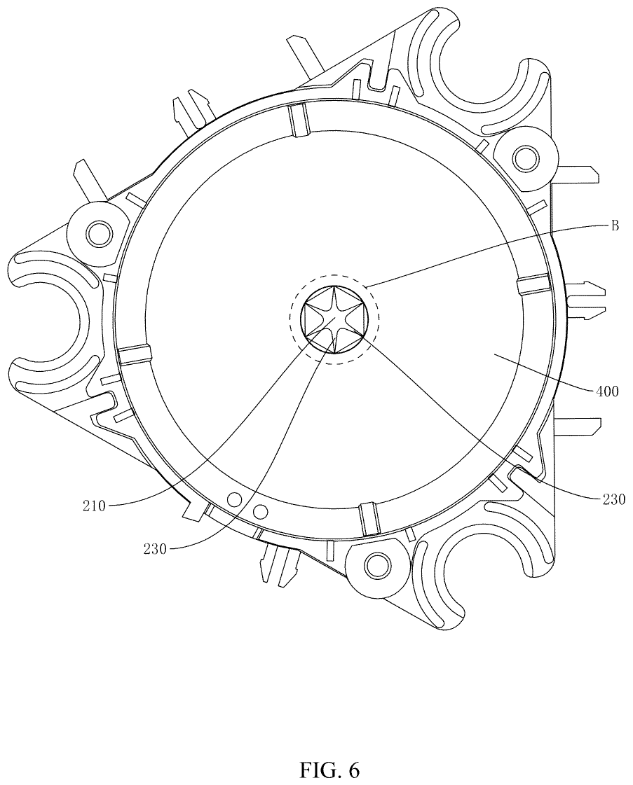

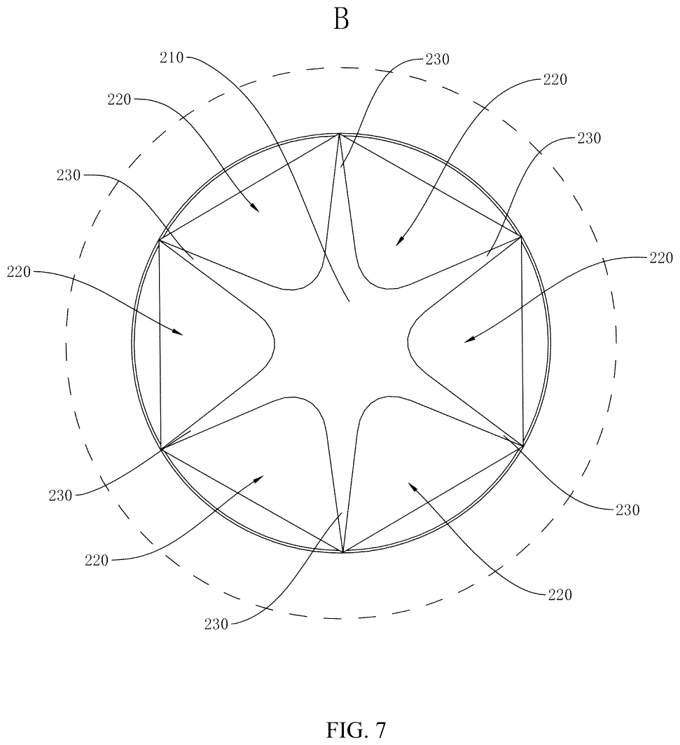

Referring to FIG. 1 to FIG. 7, a shaft connecting structure according to an embodiment in a first aspect of the present disclosure includes a first connecting shaft 100 and a second connecting shaft 200. The first connecting shaft 100 is provided with a receptacle 110 and a plurality of first correcting grooves 120. A cross section of the receptacle 110 is a regular polygon structure in a direction perpendicular to an axial direction of the first connecting shaft 100, the receptacle 110 is provided with inner angles 111. The plurality of first correcting grooves 120 are arranged at intervals in a circumferential direction of the first connecting shaft 100, each of the first correcting grooves 120 extends to an adjacent side wall of the receptacle 110, a distance between each of the first correcting grooves 120 and an axis of the first connecting shaft 100 gradually decreases in a concave direction of the receptacle 110, and a width of each of the first correcting grooves 120 gradually decreases in a direction from the receptacle 110 to the respective first correcting groove 120. The second connecting shaft 200 is provided with a protrusion 210, a cross section of the protrusion 210 is matched with the cross section of the receptacle 110 in a direction perpendicular to an axial direction of the second connecting shaft 200. The second connecting shaft 200 is provided with a plurality of second correcting grooves 220, the plurality of second correcting grooves 220 are arranged at intervals in a circumferential direction of the second connecting shaft 200. Each of the second correcting grooves 220 extends to a respective side surface of the second connecting shaft 200, a sharp part 230 is formed between the adjacent second correcting grooves 220. One end of the second connecting shaft 200 is accommodated in the receptacle 110 and is capable of moving in the circumferential direction of the first connecting shaft 100. When each of the inner angles 111 is misaligned with the respective sharp part 230, the sharp part 230 slides into the receptacle 110 from the respective first correcting groove 120, and the sharp part 230 is in sliding contact with a side wall of the first correcting groove 120, so that the protrusion 210 is inserted into the receptacle 110. This facilitates installation of a screw body 300, and reduces a working noise of a juicer while reducing a fit clearance between the protrusion 210 and the receptacle 110.

Specifically, the first connecting shaft 100 is a shaft body of the screw body 300, and the second connecting shaft 200 is an output shaft of a motor 400. When a user installs the screw body 300, the first connecting shaft 100 is connected with the second connecting shaft 200, and the user cannot accurately determine relative positions of the inner angles 111 and the respective sharp parts 230. In most cases, the inner angles 111 are misaligned with the respective sharp parts 230 both in the circumferential direction and the radial direction of the first connecting shaft 100. By providing the first correcting grooves 120 and the second correcting grooves 220, when the inner angles 111 are misaligned with the respective sharp parts 230 in the circumferential direction of the first connecting shaft 100, the sharp parts 230 are abutted with the side walls of the first correcting grooves 120. As the first correcting grooves 120 each extend to the adjacent side wall of the receptacle 110, the side walls of the first correcting grooves 120 can guide the respective sharp parts 230 to rotate in a direction towards the inner angles 111, so as to correct the positions of the inner angles 111 and the sharp parts 230 in the circumferential direction of the first connecting shaft 100. When the inner angles 111 are misaligned with the sharp parts 230 in the radial direction of the first connecting shaft 100, the distance between each of the first correcting grooves 120 and the axis of the first connecting shaft 100 gradually decreases in the concave direction of the first connecting shaft 110, so that the side walls of the first correcting grooves 120 can guide the respective sharp parts 230 to move in the radial direction of the first connecting shaft 100 to correct the positions of the inner angles 111 and the respective sharp parts 230 in the radial direction of the first connecting shaft 100. This facilitates the installation of the screw body 300, and reduces the operational noise during juicer operation while reducing the fit clearance between the protrusion 210 and the receptacle 110.

In some embodiments of the present disclosure, each of a plurality of connecting edges 130 is defined between two adjacent first correcting grooves 120 respectively, and, a length of one of the connecting edges 130 is not equal to that of other connecting edges 130, so that each of the sharp parts 230 can be prevented from contacting the wall surface of the respective first correcting grooves 120 at the same time, so as to facilitate the correction of the relative positions of the sharp parts 230 and the inner angles 111.

Specifically, in the plurality of connecting edges 130, the length of one connecting edge 130 is shorter than that of the other connecting edges 130, so that an inclination angle of a wall surface of the first correcting groove 120 next to the shorter connecting edge 130 is different from inclination angles of wall surfaces of other first correcting grooves 120. When the inner angle 111 is misaligned with the sharp part 230, a tip of the sharp part 230 is abutted with the wall surface of the first correcting groove 120 next to the shorter connecting edge 130 first, thus reducing a resistance when the protrusion 210 is inserted into the receptacle 110, and facilitating the insertion of the protrusion 210 into the receptacle 110.

It should be noted that a length of the connecting edge 130 refers to a dimension of the connecting edge 130 in the axial direction of the first connecting shaft 100, and will not be described in detail here.

It should be noted that lengths of two of the connecting edges 130 may be shorter than the lengths of the other connecting edges 130, which are not limited here.

In some embodiments of the present disclosure, each of the second correcting grooves 220 extends to the respective side surface and an end surface of the second connecting shaft 200, and a distance between a wall surface of each of the second correcting grooves 220 and the respective side surface of the second connecting shaft 200 gradually decreases in a concave direction of the respective second correcting groove 220, so that an overall structural strength of the protrusion 210 can be improved and a service life of the second connecting shaft 200 can be prolonged.

In some embodiments of the present disclosure, a width of each of the second correcting grooves 220 gradually decreases in a direction from the respective side surface of the second connecting shaft 200 to the axis of the second connecting shaft 200, so that an overall structural strength of the sharp parts 230 can be improved to prevent the sharp parts 230 from fracture and the service life of the second connecting shaft 200 can be prolonged.

Specifically, a width of the first sharp part 230 gradually increases in the concave direction of the second correcting groove 220, so that the structural strength of the sharp part 230 can be improved to prevent the sharp part 230 from fracture and the service life of the second connecting shaft 200 can be prolonged.

In some embodiments of the present disclosure, the cross section of the receptacle 110 is a regular hexagon structure in the direction perpendicular to the axial direction of the first connecting shaft 100. The cross section of the protrusion 210 is a regular hexagon structure correspondingly, so that the side surface of the second connecting shaft 200 is matched with any side wall of the receptacle 110, and the side surface of the second connecting shaft 200 does not need to correspond to any side wall of the receptacle 110, so that the first connecting shaft 100 and the second connecting shaft 200 can be conveniently connected.

It should be noted that the cross section of the receptacle 110 may also be a square structure or a regular pentagon structure, or the like, in the direction perpendicular to the axial direction of the first connecting shaft 100, which is not limited here.

In some embodiments of the present disclosure, the side wall of each of the first correcting grooves 120 is connected with the respective side wall of the adjacent first correcting groove 120 to form the respective connecting edge 130. This can reduce a width of the connecting edge 130 and thus reduce a probability that the tip of the sharp part 230 abuts against the connecting edge 130, thus facilitating the insertion of the protrusion 210 into the receptacle 110.

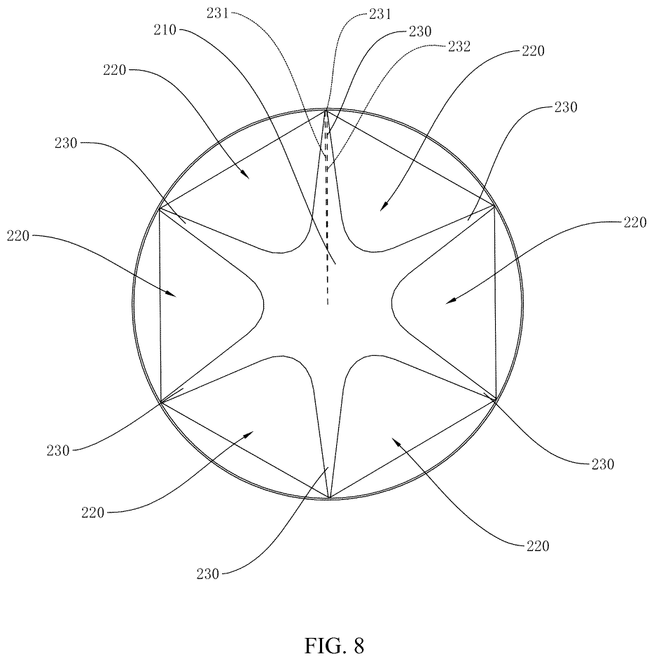

Referring to FIG. 8, in some embodiments of the present disclosure, the sharp part 230 is provided with a side edge 231. The side edge 231 is located on one side of the sharp part 230 adjacent to an outer side of the second connecting shaft 200, one end of the side edge 231 is connected with a center of the protrusion 210 to form a first edge 232, another end of the side edge 231 is connected with the center of the protrusion 210 to form a second edge 232, and an included angle between the first edge 231 and the second edge 232 is α, which satisfies: 0<α≤3°. This can reduce a probability that the side edge 231 abuts against the connecting edge 130, so as to facilitate the insertion of the protrusion 210 into the receptacle 110.

Specifically, taking the cross section of the protrusion 210 as a circumscribed circle, when α is 1°, a sum of central angles occupied by the six side edges 231 is 6°. In this case, the side edge 231 has only one-sixtieth probability of abutting against the connecting edge 130. When α is 2°, the sum of the central angles occupied by the six side edges 231 is 12°. In this case, the side edge 231 has only one-thirtieth probability of abutting against the connecting edge 130, which can reduce the probability of the side edge 231 of abutting against the connecting edge 130, so as to facilitate the insertion of the protrusion 210 into the receptacle 110. Therefore, only the side edge 231 of the sharp part 230 abuts against the side wall of the first correcting groove 120, which can avoid the situation that the side edge of the sharp part 230 is in contact with the side wall of the first correcting groove 120, thereby reducing a slip resistance of the sharp part 230, and facilitating the insertion of the protrusion 210 into the receptacle 110.

In some embodiments of the present disclosure, a projection of each of the inner angles 111 is located in a middle of a projection of the respective first correcting groove 120 in the axial direction of the first connecting shaft 100. When the tip of the sharp part 230 abuts against one side of the first correcting groove 120, the tip of the sharp part 230 can smoothly slide to a middle of the first correcting groove 120, which can facilitate the insertion of the protrusion 210 into the receptacle 110.

In some embodiments of the present disclosure, a bottom wall of each of the first correcting grooves 120 is a curved surface structure, which can avoid a situation that the tip of the sharp part 230 is locked with the bottom wall of the first correcting groove 120, thus facilitating the insertion of the protrusion 210 into the receptacle 110.

Specifically, the cross section of the first correcting groove 120 is V-shaped in the direction perpendicular to the axial direction of the first connecting shaft 100, and a bottom part of the first correcting groove 120 is arc-shaped, which can avoid the situation that the tip of the sharp part 230 is locked with the bottom wall of the first correcting groove 120, thus facilitating the insertion of the protrusion 210 into the receptacle 110.

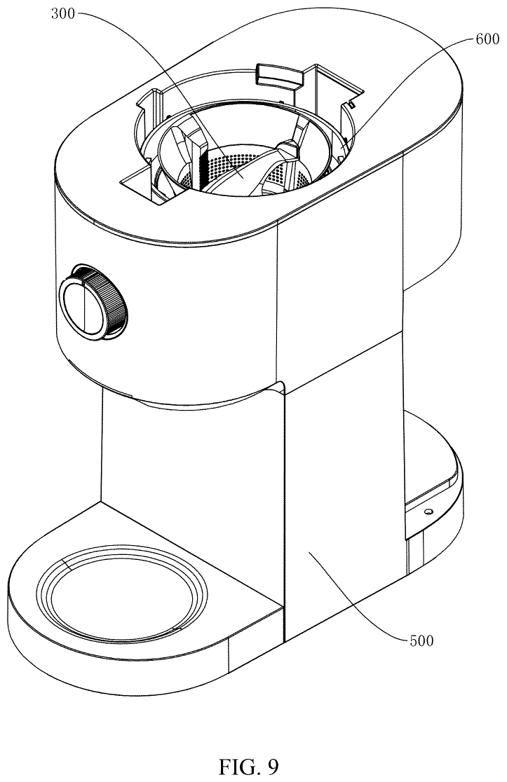

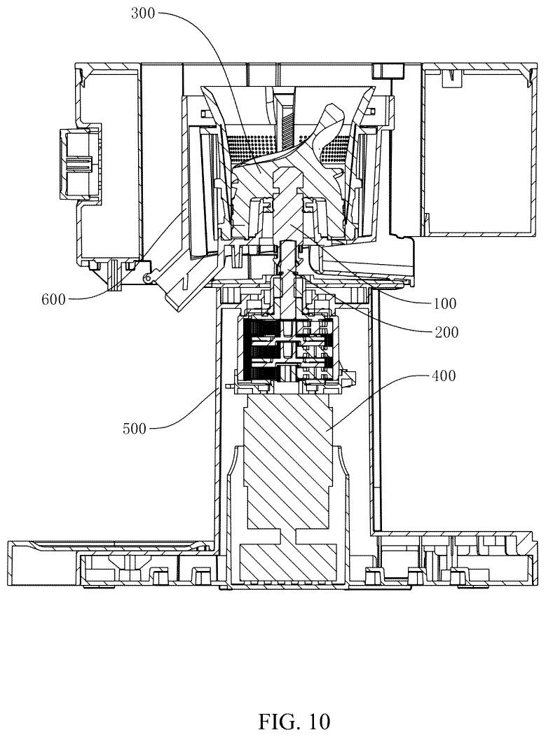

Referring to FIG. 9 and FIG. 10, a juicer according to an embodiment in a second aspect of the present disclosure includes a motor 400, a screw body 300 and the shaft connecting structure in the first aspect of the present disclosure. The first connecting shaft 100 is a shaft body of the screw body 300, and the second connecting shaft 200 is an output shaft of the motor 400.

Specifically, when a user installs the screw body 300, the first connecting shaft 100 is connected with the second connecting shaft 200, and the user cannot accurately determine relative positions of the inner angles 111 and the respective sharp parts 230. In most cases, the inner angles 111 are misaligned with the respective sharp parts 230 both in the circumferential direction and the radial direction of the first connecting shaft 100. By providing the first correcting grooves 120 and the second correcting grooves 220, when the inner angles 111 are misaligned with the respective sharp parts 230 in the circumferential direction of the first connecting shaft 100, the sharp parts 230 are abutted with the side walls of the first correcting grooves 120. As the first correcting grooves 120 each extend to the adjacent side wall of the receptacle 110, the side walls of the first correcting grooves 120 can guide the respective sharp parts 230 to rotate in a direction towards the inner angles 111, so as to correct the positions of the inner angles 111 and the sharp parts 230 in the circumferential direction of the first connecting shaft 100. When the inner angles 111 are misaligned with the sharp parts 230 in the radial direction of the first connecting shaft 100, the distance between each of the first correcting grooves 120 and the axis of the first connecting shaft 100 gradually decreases in the concave direction of the first connecting shaft 110, so that the side walls of the first correcting grooves 120 can guide the respective sharp parts 230 to move in the radial direction of the first connecting shaft 100 to correct the positions of the inner angles 111 and the respective sharp parts 230 in the radial direction of the first connecting shaft 100. This facilitates the installation of the screw body 300, and reduces the operational noise during juicer operation while reducing the fit clearance between the protrusion 210 and the receptacle 110.

It should be noted that the juicer further includes a base 500 and a juicing cup 600. The motor 400 is arranged on the base 500, the juicing cup 600 is detachably installed on the base 500, the second connecting shaft 200 extends into the juicing cup 600, and the second connecting shaft 200 is matched with the protrusion 210 through the receptacle 110 and connected with the first connecting shaft 100, which will not be described here again.

All the technical features of the above embodiments may be combined at will. In order to make the description concise, not all possible combinations of the technical features in the above embodiments are described. However, as long as there is no contradiction between the combinations of these technical features, they should be considered as the scope recorded in this specification.

The embodiments of the present disclosure are described in detail with reference to the drawings above, but the present disclosure is not limited to the above embodiments, and various changes may also be made within the knowledge scope of those of ordinary skills in the art without departing from the purpose of the present disclosure.

What is claimed is:

1. A shaft connecting structure for a juicer, comprising:
a first connecting shaft provided with a receptacle and a plurality of first correcting grooves, wherein a cross section of the receptacle is a regular polygon structure in a direction perpendicular to an axial direction of the first connecting shaft, the receptacle is provided with inner angles, the plurality of first correcting grooves are arranged at intervals in a circumferential direction of the first connecting shaft, each of the first correcting grooves extends to an adjacent side wall of the receptacle, a distance between each of the first correcting grooves and an axis of the first connecting shaft gradually decreases in a concave direction of the receptacle, and a width of each of the first correcting grooves gradually decreases in a direction from the receptacle to the respective first correcting groove; and
a second connecting shaft provided with a protrusion, wherein a cross section of the protrusion is matched with the cross section of the receptacle in a direction perpendicular to an axial direction of the second connecting shaft, the second connecting shaft is provided with a plurality of second correcting grooves, the plurality of second correcting grooves are arranged at intervals in a circumferential direction of the second connecting shaft, each of the second correcting grooves extends to a respective side surface of the second connecting shaft, a sharp part is formed between the adjacent second correcting grooves, and one end of the second connecting shaft is accommodated in the receptacle and is capable of moving in the circumferential direction of the first connecting shaft;
wherein, when each of the inner angles is misaligned with the respective sharp part, the sharp part slides into the receptacle from the respective first correcting groove, and the sharp part is in sliding contact with a side wall of the respective first correcting groove, so that the protrusion is inserted into the receptacle.

2. The shaft connecting structure according to claim 1, wherein each of a plurality of connecting edges is defined between two adjacent first correcting grooves respectively, and a length of one of the connecting edges is not equal to a length of other connecting edges.

3. The shaft connecting structure according to claim 1, wherein a distance between a wall surface of each of the second correcting grooves and the respective side surface of the second connecting shaft gradually decreases in a concave direction of the respective second correcting groove.

4. The shaft connecting structure according to claim 1, wherein a width of each of the second correcting grooves gradually decreases in a direction from the respective side surface of the second connecting shaft to an axis of the second connecting shaft.

5. The shaft connecting structure according to claim 1, wherein the cross section of the receptacle is a regular hexagon structure in the direction perpendicular to the axial direction of the first connecting shaft.

6. The shaft connecting structure according to claim 1, wherein a side wall of each of the first correcting grooves is connected with a respective side wall of an adjacent first correcting groove.

7. The shaft connecting structure according to claim 1, wherein the sharp part is provided with a side edge, the side edge is located on one side of the sharp part adjacent to an outer side of the second connecting shaft, one end of the side edge is connected with a center of the protrusion to form a first edge, another end of the side edge is connected with the center of the protrusion to form a second edge, and an included angle between the first edge and the second edge is α, which satisfies: 0<α≤3°.

8. The shaft connecting structure according to claim 1, wherein a projection of each of the inner angles is located in a middle of a projection of the respective first correcting groove in the axial direction of the first connecting shaft.

9. The shaft connecting structure according to claim 1, wherein a bottom wall of each of the first correcting grooves is a curved surface structure.

10. A juicer, comprising a motor, a screw body and the shaft connecting structure according to claim 1, wherein the first connecting shaft is a shaft body of the screw body, and the second connecting shaft is an output shaft of the motor.
